(19) United States
(12) Patent Application Publication
(10) Pub. No.: US 2026/0255434 A1
(43) Pub. Date: Aug. 27, 2026

(54) APPARATUS, METHOD AND COMPUTER PROGRAM

(71) Applicant: Nokia Technologies Oy, Espoo (FI)

(72) Inventors: Mads LAURIDSEN, Aalborg (DK); Xiang XU, Beijing (CN); Srinivasan SELVAGANAPATHY, Bangalore (IN); Jeroen WIGARD, Aalborg (DK)

(21) Appl. No.: 18/872,558

(22) PCT Filed: Aug. 1, 2022
(86) PCT No.: PCT/CN2022/109534

§ 371 Date: Dec. 6, 2024

(51) Int. Cl. H04W 76/28

(52) U.S. Cl. CPC H04W 76/28

(57) ABSTRACT

There is provided an apparatus, said apparatus comprising: at least one processor and at least one memory storing instructions that, when executed by the at least one processor, cause the apparatus at least to provide data from a user equipment to a first base station, the first base station having discontinuous connectivity with a core network and receive from the first base station, first information comprising an indication of at least one further base station from which feedback information associated with the data is to be provided at a later point in time, the at least one further base station having discontinuous connectivity with the core network.

### FIELD

The present application relates to a method, apparatus, system and computer program and in particular but not exclusively to provisioning of feedback time/satellite in store and forward Non-terrestrial networks (NTN).

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

In a first aspect there is provided an apparatus comprising: at least one processor and at least one memory storing instructions that, when executed by the at least one processor, cause the apparatus at least to provide data from a user equipment to a first base station, the first base station having discontinuous connectivity with a core network and receive from the first base station, first information comprising an indication of at least one further base station from which feedback information associated with the data is to be provided at a later point in time, the at least one further base station having discontinuous connectivity with the core network.

The first information may comprise an indication of a time when the at least one further base station will provide coverage to the user equipment.

The indication of the at least one further base station may comprise an indication of a cell or a tracking area associated with the at least one further base station.

The apparatus may be caused to receive the first information in user equipment specific signalling or in broadcast information.

The first base station and the at least one further base station may comprise a mobile base station.

The mobile base station may be mounted on a non-terrestrial satellite.

The apparatus may be further caused to receive second information comprising an indication from the at least one further base station that the feedback information is deferred.

The second information may comprise an indication of a second further non base station from which the feedback information is to be provided.

The second information may comprise an indication of a time when the at least one second further base station will provide coverage to the user equipment.

The indication of the at least one second further base station may comprise an indication of a cell or a tracking area associated with the at least one second further base station.

The apparatus may be caused to receive the second information in user equipment specific signalling or in broadcast information.

In a second aspect there is provided an apparatus comprising: at least one processor and at least one memory storing instructions that, when executed by the at least one processor, cause the apparatus at least to receive, at a first base station, data from a user equipment, the first base station having discontinuous connectivity with a core network and provide, to the user equipment and to the core network from the first base station, first information comprising an indication of at least one further base station from which feedback information associated with the received data is to be provided at a later point in time, the at least one further base station having discontinuous connectivity with the core network.

The apparatus may be caused to receive location information for gateways of the core network and determine the at least one further base station based on the location information.

The apparatus may be caused to receive at least one of location information and coverage information for the first base station and a plurality of further base stations and determine the at least one further base station based on the at least one of location information and coverage information.

The apparatus may be caused to determine the at least one further base station based on predicted movement of the user equipment.

The apparatus may be caused to receive an indication of the at least one further base station from the core network.

The first information may comprise an indication of a time when the at least one further base station will provide coverage to the user equipment.

The indication of the at least one further base station may comprise an indication of a cell or a tracking area associated with the at least one further base station.

The apparatus may be caused to provide the first information in user equipment specific signalling or in broadcast information.

The first base station and the at least one further base station may comprise a mobile base station.

The mobile base station may be mounted on a non-terrestrial satellite.

The apparatus may be further caused to provide second information to the user equipment comprising an indication that the feedback information is deferred.

The second information may comprise an indication of a second further non base station from which the feedback information is to be provided.

The second information may comprise an indication of a time when the at least one second further base station will provide coverage to the user equipment.

The indication of the at least one second further base station may comprise an indication of a cell or a tracking area associated with the at least one second further base station.

The apparatus may be caused to provide the second information in user equipment specific signalling or in broadcast information.

In a third aspect there is provided a method comprising providing data from a user equipment to a first base station, the first base station having discontinuous connectivity with a core network and receiving from the first base station, first information comprising an indication of at least one further base station from which feedback information associated with the data is to be provided at a later point in time, the at least one further base station having discontinuous connectivity with the core network.

The first information may comprise an indication of a time when the at least one further base station will provide coverage to the user equipment.

The indication of the at least one further base station may comprise an indication of a cell or a tracking area associated with the at least one further base station.

The method may comprise receiving the first information in user equipment specific signalling or in broadcast information.

The first base station and the at least one further base station may comprise a mobile base station.

The mobile base station may be mounted on a non-terrestrial satellite.

The method may comprise receiving second information comprising an indication from the at least one further base station that the feedback information is deferred.

The second information may comprise an indication of a second further non base station from which the feedback information is to be provided.

The second information may comprise an indication of a time when the at least one second further base station will provide coverage to the user equipment.

The indication of the at least one second further base station may comprise an indication of a cell or a tracking area associated with the at least one second further base station.

The method may comprise receiving the second information in user equipment specific signalling or in broadcast information.

In a fourth aspect there is provided a method comprising receiving, at a first base station, data from a user equipment, the first base station having discontinuous connectivity with a core network and providing, to the user equipment and to the core network from the first base station, first information comprising an indication of at least one further base station from which feedback information associated with the received data is to be provided at a later point in time, the at least one further base station having discontinuous connectivity with the core network.

The method may comprise receiving location information for gateways of the core network and determining the at least one further base station based on the location information.

The method may comprise receiving at least one of location information and coverage information for the first base station and a plurality of further base stations and determining the at least one further base station based on the at least one of location information and coverage information.

The method may comprise determining the at least one further base station based on predicted movement of the user equipment.

The method may comprise receiving an indication of the at least one further base station from the core network.

The first information may comprise an indication of a time when the at least one further base station will provide coverage to the user equipment.

The indication of the at least one further base station may comprise an indication of a cell or a tracking area associated with the at least one further base station.

The method may comprise providing the first information in user equipment specific signalling or in broadcast information.

The first base station and the at least one further base station may comprise a mobile base station.

The mobile base station may be mounted on a non-terrestrial satellite.

The method may comprise providing second information to the user equipment comprising an indication that the feedback information is deferred.

The second information may comprise an indication of a second further non base station from which the feedback information is to be provided.

The second information may comprise an indication of a time when the at least one second further base station will provide coverage to the user equipment.

The indication of the at least one second further base station may comprise an indication of a cell or a tracking area associated with the at least one second further base station.

The method may comprise providing the second information in user equipment specific signalling or in broadcast information.

In a fifth aspect there is provided an apparatus comprising means for providing data from a user equipment to a first base station, the first base station having discontinuous connectivity with a core network and means for receiving from the first base station, first information comprising an indication of at least one further base station from which feedback information associated with the data is to be provided at a later point in time, the at least one further base station having discontinuous connectivity with the core network.

The first information may comprise an indication of a time when the at least one further base station will provide coverage to the user equipment.

The indication of the at least one further base station may comprise an indication of a cell or a tracking area associated with the at least one further base station.

The apparatus may comprise means for receiving the first information in user equipment specific signalling or in broadcast information.

The first base station and the at least one further base station may comprise a mobile base station.

The mobile base station may be mounted on a non-terrestrial satellite.

The apparatus may comprise means for receiving second information comprising an indication from the at least one further base station that the feedback information is deferred.

The second information may comprise an indication of a second further non base station from which the feedback information is to be provided.

The second information may comprise an indication of a time when the at least one second further base station will provide coverage to the user equipment.

The indication of the at least one second further base station may comprise an indication of a cell or a tracking area associated with the at least one second further base station.

The apparatus may comprise means for receiving the second information in user equipment specific signalling or in broadcast information.

In a sixth aspect there is provided an apparatus comprising means for comprising receiving, at a first base station, data from a user equipment, the first base station having discontinuous connectivity with a core network and means for providing, to the user equipment and to the core network from the first base station, first information comprising an indication of at least one further base station from which feedback information associated with the received data is to be provided at a later point in time, the at least one further base station having discontinuous connectivity with the core network.

The apparatus may comprise means for receiving location information for gateways of the core network and determining the at least one further base station based on the location information.

The apparatus may comprise means for receiving at least one of location information and coverage information for the first base station and a plurality of further base stations and means for determining the at least one further base station based on the at least one of location information and coverage information.

The apparatus may comprise means for determining the at least one further base station based on predicted movement of the user equipment.

The apparatus may comprise means for receiving an indication of the at least one further base station from the core network.

The first information may comprise an indication of a time when the at least one further base station will provide coverage to the user equipment.

The indication of the at least one further base station may comprise an indication of a cell or a tracking area associated with the at least one further base station.

The apparatus may comprise means for providing the first information in user equipment specific signalling or in broadcast information.

The first base station and the at least one further base station may comprise a mobile base station.

The mobile base station may be mounted on a non-terrestrial satellite.

The apparatus may comprise means for providing second information to the user equipment comprising an indication that the feedback information is deferred.

The second information may comprise an indication of a second further non base station from which the feedback information is to be provided.

The second information may comprise an indication of a time when the at least one second further base station will provide coverage to the user equipment.

The indication of the at least one second further base station may comprise an indication of a cell or a tracking area associated with the at least one second further base station.

The apparatus may comprise means for providing the second information in user equipment specific signalling or in broadcast information.

In a seventh aspect there is provided a computer readable medium comprising program instructions for causing an apparatus to perform at least the following, providing data from a user equipment to a first base station, the first base station having discontinuous connectivity with a core network and receiving from the first base station, first information comprising an indication of at least one further base station from which feedback information associated with the data is to be provided at a later point in time, the at least one further base station having discontinuous connectivity with the core network.

The first information may comprise an indication of a time when the at least one further base station will provide coverage to the user equipment.

The indication of the at least one further base station may comprise an indication of a cell or a tracking area associated with the at least one further base station.

The apparatus may be caused to perform receiving the first information in user equipment specific signalling or in broadcast information.

The first base station and the at least one further base station may comprise a mobile base station.

The mobile base station may be mounted on a non-terrestrial satellite.

The apparatus may be caused to perform receiving second information comprising an indication from the at least one further base station that the feedback information is deferred.

The second information may comprise an indication of a second further non base station from which the feedback information is to be provided.

The second information may comprise an indication of a time when the at least one second further base station will provide coverage to the user equipment.

The indication of the at least one second further base station may comprise an indication of a cell or a tracking area associated with the at least one second further base station.

The apparatus may be caused to perform receiving the second information in user equipment specific signalling or in broadcast information.

In an eighth aspect there is provided a computer readable medium comprising program instructions for causing an apparatus to perform at least the following receiving, at a first base station, data from a user equipment, the first base station having discontinuous connectivity with a core network and providing, to the user equipment and to the core network from the first base station, first information comprising an indication of at least one further base station from which feedback information associated with the received data is to be provided at a later point in time, the at least one further base station having discontinuous connectivity with the core network.

The apparatus may be caused to perform receiving location information for gateways of the core network and determining the at least one further base station based on the location information.

The apparatus may be caused to perform receiving at least one of location information and coverage information for the first base station and a plurality of further base stations and determining the at least one further base station based on the at least one of location information and coverage information.

The apparatus may be caused to perform determining the at least one further base station based on predicted movement of the user equipment.

The apparatus may be caused to perform receiving an indication of the at least one further base station from the core network.

The first information may comprise an indication of a time when the at least one further base station will provide coverage to the user equipment.

The indication of the at least one further base station may comprise an indication of a cell or a tracking area associated with the at least one further base station.

The apparatus may be caused to perform providing the first information in user equipment specific signalling or in broadcast information.

The first base station and the at least one further base station may comprise a mobile base station.

The mobile base station may be mounted on a non-terrestrial satellite.

The apparatus may be caused to perform providing second information to the user equipment comprising an indication that the feedback information is deferred.

The second information may comprise an indication of a second further non base station from which the feedback information is to be provided.

The second information may comprise an indication of a time when the at least one second further base station will provide coverage to the user equipment.

The indication of the at least one second further base station may comprise an indication of a cell or a tracking area associated with the at least one second further base station.

The apparatus may be caused to perform providing the second information in user equipment specific signalling or in broadcast information.

In a ninth aspect there is provided a non-transitory computer readable medium comprising program instructions for causing an apparatus to perform at least the method according to the third or fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example 5GS communication system;

FIG. 2 shows a schematic diagram of an example mobile communication device;

FIG. 3 shows a schematic diagram of an example control apparatus;

FIG. 4 shows a NTN scenario at given time intervals;

FIG. 5 shows a block diagram of a DTN ground network;

FIG. 6 shows a flowchart of a method according to an example embodiment;

FIG. 7 shows a flowchart of a method according to an example embodiment;

FIG. 8 shows a NTN scenario at given time intervals according to an example embodiment;

FIG. 9 shows an example signalling flow for the scenario of FIG. 8;

FIG. 10 shows a flowchart of an example method for identification of target satellites.

### DETAILED DESCRIPTION

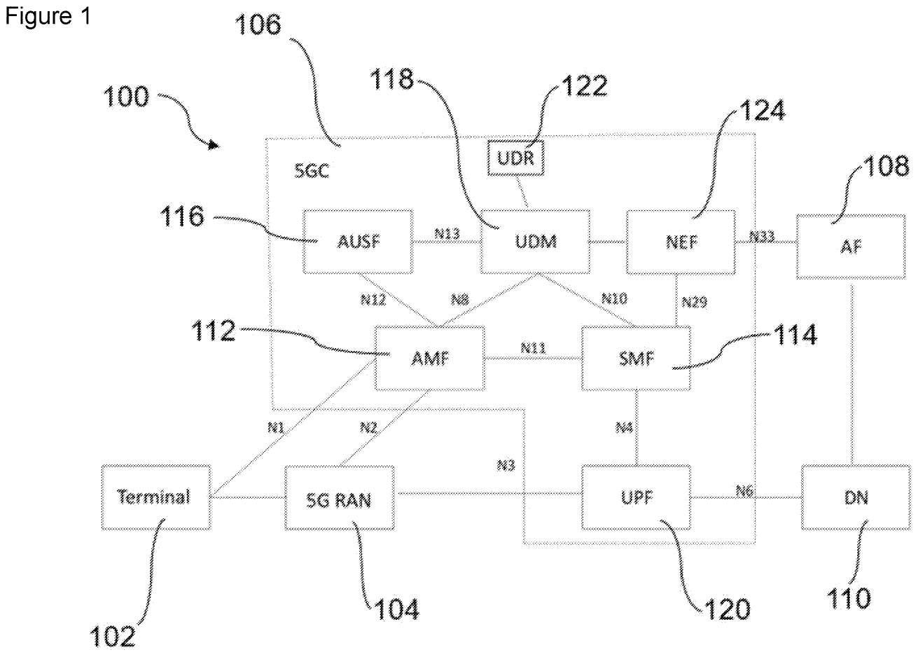

Before explaining in detail the examples, certain general principles of a wireless communication system and mobile communication devices are briefly explained with reference to FIGS. 1 to 3 to assist in understanding the technology underlying the described examples.

An example of a suitable communications system is the 5G System (5GS). Network architecture in 5GS may be similar to that of LTE-advanced. Base stations of NR systems may be known as next generation Node Bs (gNBs). Changes to the network architecture may depend on the need to support various radio technologies and finer QoS support, and some on-demand requirements for example QoS levels to support QoE of user point of view. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

5G networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more application functions (AF) 108 and one or more data networks (DN) 110.

An example 5G core network (CN) comprises functional entities. The 5GCN 106 may comprise one or more access and mobility management functions (AMF) 112, one or more session management functions (SMF) 114, an authentication server function (AUSF) 116, a unified data management (UDM) 118, one or more user plane functions (UPF) 120, a unified data repository (UDR) 122 and/or a network exposure function (NEF) 124. The UPF is controlled by the SMF (Session Management Function) that receives policies from a PCF (Policy Control Function).

The CN is connected to a terminal device via the radio access network (RAN). The 5GRAN may comprise one or more gNodeB (GNB) distributed unit functions connected to one or more gNodeB (GNB) centralized unit functions. The RAN may comprise one or more access nodes.

A UPF (User Plane Function) whose role is called PSA (Protocol Data Unit (PDU) Session Anchor) may be responsible for forwarding frames back and forth between the DN (data network) and the tunnels established over the 5G towards the UE(s) exchanging traffic with the DN.

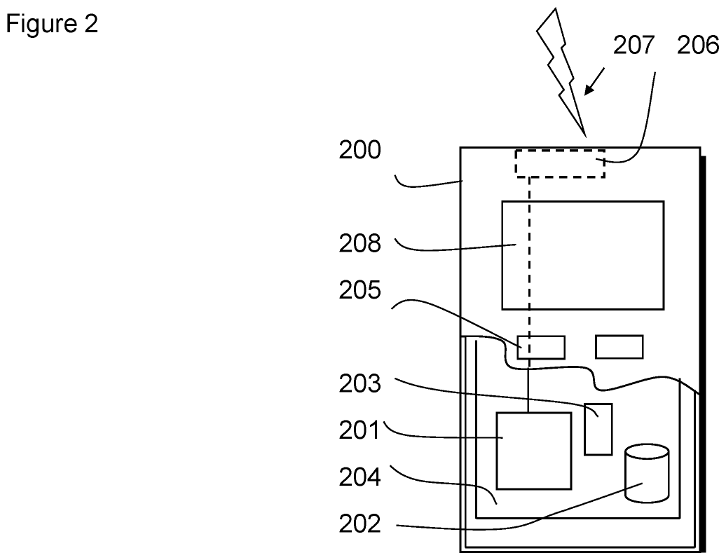

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VOIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

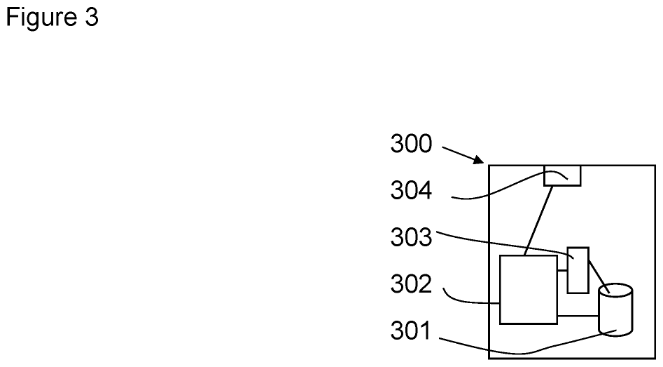

FIG. 3 shows an example of a control apparatus 300 for a communication system, for example to be coupled to and/or for controlling a station of an access system, such as a RAN node, e.g. a base station, eNB or gNB, a relay node or a core network node such as an MME or serving gateway (S-GW) or packet data network gateway (P-GW), or a core network function such as AMF/SMF, or a server or host. The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

The following targets non-terrestrial networks (NTN), which have been defined for NR and Narrowband (NB)-Internet of Things (IoT)/enhanced Machine Type Communication (eMTC).

A store and forward operation has been proposed for IoT NTN. Store-and-forward (S&F) is a feature that will allow a satellite to provide service to IoT NTN devices even in periods or areas where the satellite is not connected to a Gateway (GW) on the ground. An eNB on board architecture is assumed. Non simultaneous operation of the service link and the feeder link is assumed. Messages are stored on board until there is line of sight with the GW. The support of decoupled signalling procedures “UE<->Satellite with onboard RAN node” and “Satellite with onboard RAN node<->CN on the ground” for achieving end-to-end functionality is required, as well as a dynamic attachment between S-GW and eNB.

The store and forward operation builds on the concept of discontinuous coverage scenario, where the UE only occasionally and temporarily has coverage from a satellite. The discontinuous coverage scenario is expanded by defining that the satellite is not always connected with the core network.

The store and forward architecture enables a low-cost deployment consisting of just a few satellites and a few ground stations. This means the connectivity cost per device can be further reduced at the cost of only being able to support delay tolerant data.

The following relates to the order in which satellites connect with UEs and NTN-GWs, respectively. The order impacts whether a certain satellite (SAT) will carry relevant information for the UE or not.

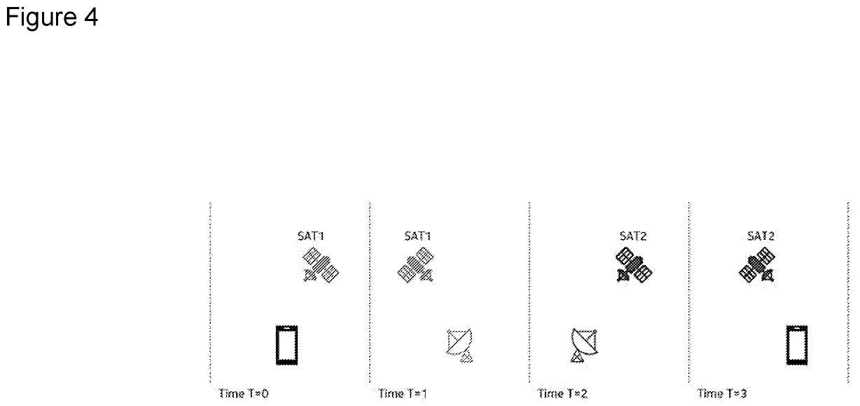

FIG. 4 illustrates a scenario, where Satellite1 (SAT1) receives data from the UE at time T=0. At T=1 the SAT1 transfers the data to the core network. The data results in downlink feedback, which the core network sends to the SAT2 at T=2. At T=3 the SAT2 transfers the feedback to the UE. However, if SAT2 either has core network connectivity before T=1 or after T=3 (and not between T=1 and T=3), the SAT2 may not able to provide the feedback to the UE. After T=3, SAT2 would be able to provide feedback, but it will arrive later at the UE.

In release 17, RAN2 has agreed that the network will provide satellite assistance information (i.e. ephemeris data) to the UE, which concerns satellites which will provide coverage to the area of the UE in the future. The satellite assistance information can be used by the UE to predict when to wake up to transfer data and/or monitor for paging. The information is contained in System Information Block (SIB) 32.

In legacy space-based communication there are delay/disruption tolerant networking protocols.

For example, Delay/Disruption Tolerant Networking (DTN) is a suite of standard protocols that use information within the data stream (headers attached to data units) to accomplish end-to-end data delivery through network nodes. DTN enables data delivery in situations that involve disconnections (e.g., end-to-end link unavailability), delays (e.g., Deep Space missions) and data rate mismatches (e.g., high data rate Science downlinks but lower rate terrestrial connections).

A DTN architecture is a store-and-forward communications architecture in which source nodes send DTN bundles through a network to destination nodes.

The Space Packet Protocol supports a path addressing capability, essentially the ability to forward packets across a managed end-to-end data path through the network, but this capability has never been implemented in a space system. No provisions are made for addressing the scheduled nature of connectivity, nor does the space packet protocol support any of the DTN capabilities listed above (beyond a simple unreliable data transport).

Consultative Committee for Space Data Systems (CCSDS) File Delivery Protocol (CFDP) is a file transfer protocol that provides reliable delivery of files, and includes its own optional application-layer store-and-forward mechanisms. These store-and-forward operations form the basis for the DTN reliable data transfer mechanisms, but CFDP itself only supports file transfers (not messaging, streaming, or other applications).

These concepts are focused on delivery of data in bundles rather than routing of application layer feedback.

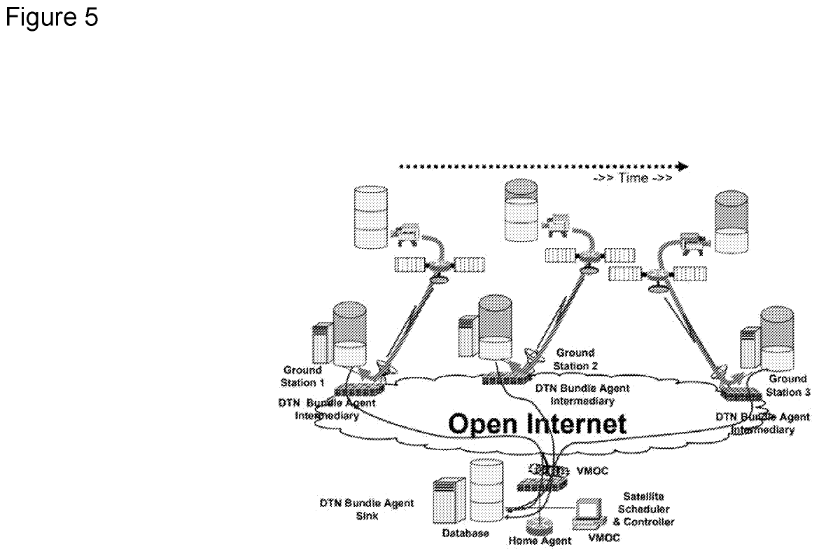

FIG. 5 shows an example of CFDP.

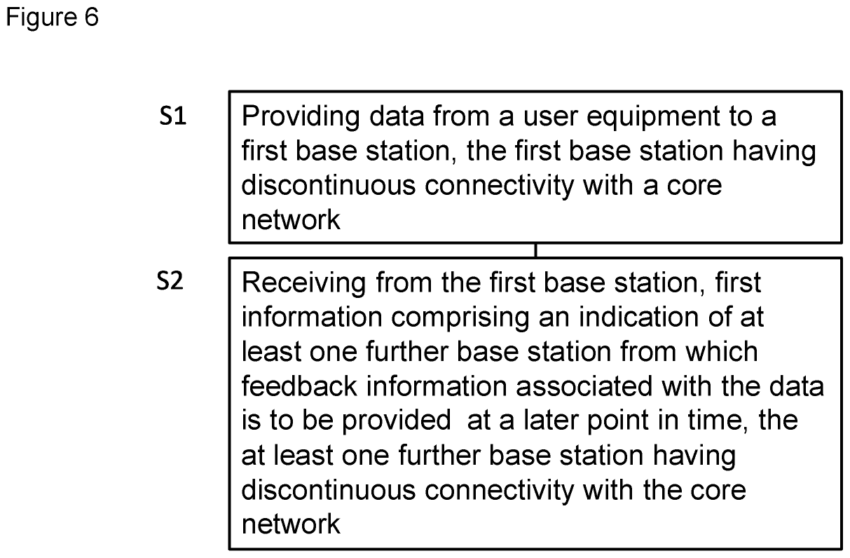

FIG. 6 shows a flowchart of a method according to an example embodiment. The method may be performed at a user equipment

In S1, the method comprises providing data from a user equipment to a first base station, the first base station having discontinuous connectivity with a core network.

In S2, the method comprises receiving, from the first base station, first information comprising an indication of at least one further base station from which feedback information associated with the data is to be provided at a later point in time, the at least one further base station having discontinuous connectivity with the core network.

The method may comprise receiving the feedback information associated with the data from the at least one further base station.

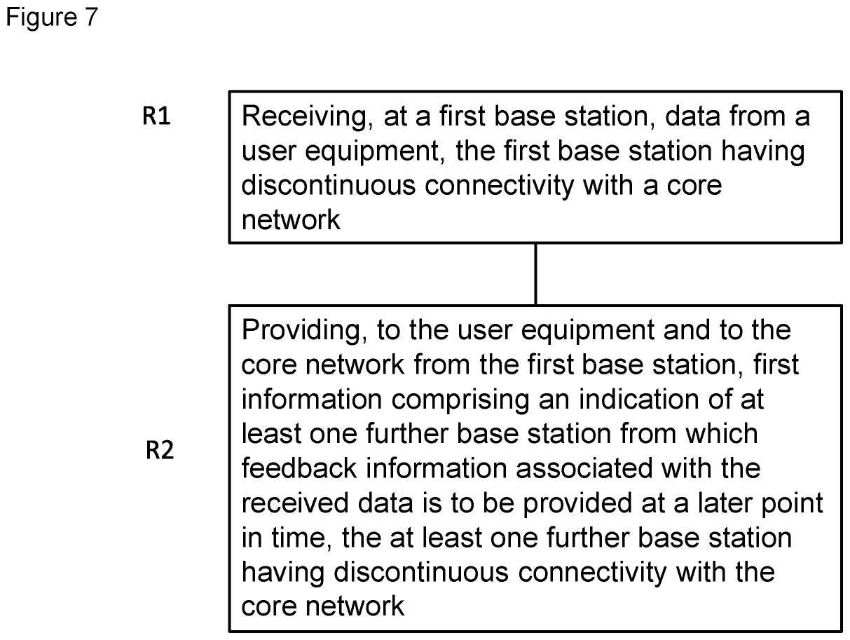

FIG. 7 shows a flowchart of a method according to an example embodiment. The method may be performed at a base station (e.g., eNB or gNB) having discontinuous connectivity with a core network.

In R1, the method comprises receiving, at a first base station, data from a user equipment, the first base station having discontinuous connectivity with a core network.

In R2, the method comprises providing, to the user equipment and to the core network from the first base station, first information comprising an indication of at least one further base station from which feedback information associated with the received data is to be provided at a later point in time, the at least one further base station having discontinuous connectivity with the core network.

The first base station and the at least one further base station may comprise a mobile base station. The mobile base station may be mounted on a vehicle such as a satellite of a NTN.

The first information may comprise an indication of a time when the at least one further non-terrestrial base station will provide coverage to the user equipment.

The indication of the at least one further base station may comprise an indication of a cell or a tracking area associated with the at least one further base station.

The first information may be provided to the user equipment in user equipment specific signalling or in broadcast information.

In an example embodiment, the first base station is a serving cell (Satellite1 (SAT1) in the example of FIG. 4) which receives uplink data from a user equipment and enhances the satellite assistance information with first information including an indication of at least one satellite(s)/cell(s) will be able to provide feedback information associated with the data and when the feedback information will be available in the area of the UE (in other words when the at least one further base station will provide coverage to the UE). SAT1 is aware of future satellites/cells in the area of the UE, and SAT1 informs the core network how to route the feedback to the right satellites/cells.

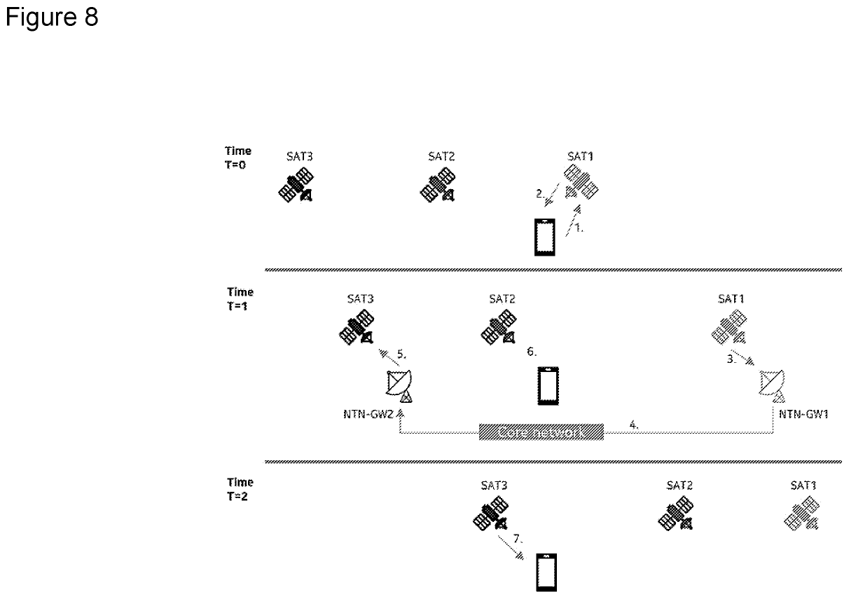

FIG. 8 provides an illustration of how the method may be applied in the store & forward scenario.

At time T=0, UE transfers data to SAT1. SAT1 is aware that the UE expects feedback to the data.

SAT1 then indicates to UE that SAT3 will provide feedback. SAT1 may provide the time when SAT3 will be available for the UE. SAT 1 may provide information about multiple satellites (and times) if it is not 100% sure which SAT will be able to provide feedback. Alternatively, or in addition, the SAT1 may indicate cells (e.g., by Physical Cell Identities (PCI)) or tracking area(s) to carry the feedback. The indication may be in UE-specific signaling or broadcast information for the current cell or tracking area.

At time T=1, SAT1 provides the data to the core network via NTN-GW1. SAT1 may inform the CN that SAT3 shall provide the feedback to the UE, alternatively that feedback shall be sent to the (tracking) area/location of the UE.

The core network obtains feedback information for the data and relays the feedback to the NTN-GW2 serving SAT3

SAT3 receives the feedback from the NTN-GW2

At this time, the UE may transfer data to SAT2 and monitor paging etc., but does not receive feedback to the data.

At time T=2, SAT3 transfers the feedback information to the UE.

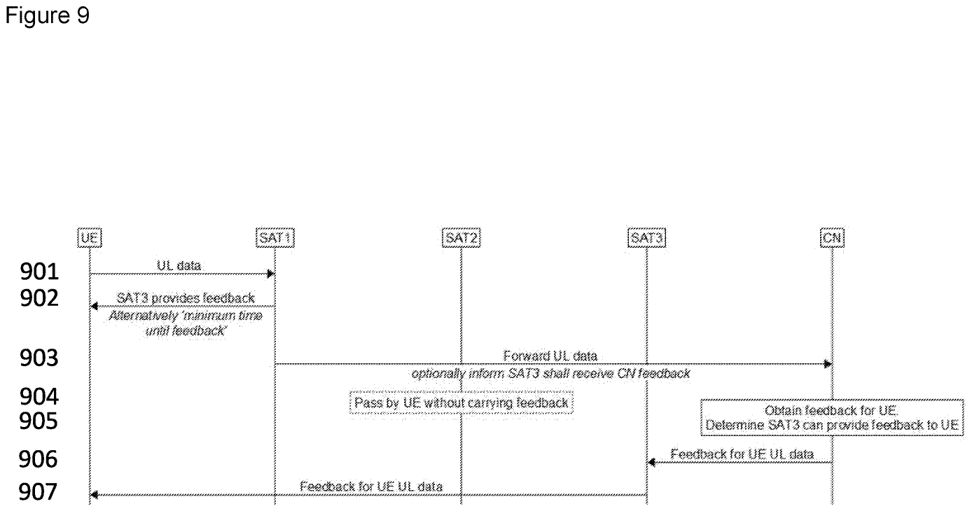

FIG. 9 shows a signalling flow according to example embodiments. The signalling flow may be used in a scenario comprising a UE, SAT1, SAT2, SAT3 and CN as described with reference to FIG. 9.

At 901, the UE provides UL data to SAT1.

At 902, SAT1 provides an indication to the UE that SAT3 will provide feedback information. Alternatively, or in addition, SAT1 may provide an indication to the UE of the minimum time until feedback.

At 903, SAT1 provides the data to the CN. SAT1 may optionally provide an indication to the CN that SAT3 shall provide the feedback to the UE.

At 904, SAT2 passes by the UE but does not provide feedback.

At 905, the CN obtains feedback information associated with the data for the UE and determines that SAT3 can provide the feedback information to the UE.

At 906, the CN provides the feedback information to SAT3.

At 907, SAT3 provides the feedback information to the UE.

The method may comprise providing second information comprising an indication to the user equipment that the feedback information is deferred. The second information may comprise an indication of a second further base station from which the feedback information is to be provided at a later point in time. The indication of the at least one second further base station comprises an indication of a cell or a tracking area associated with the at least one second further base station The second information comprises an indication of a time when the at least one second further base station will provide coverage to the user equipment. The at least one second further base station may comprise a mobile base station. The mobile base station may be mounted on a vehicle such as a satellite of an NTN. The method may comprise receiving the second information in user equipment specific signalling or in broadcast information.

For example, if the prediction of which cell/satellite provides feedback is incorrect or the feedback was not available as soon as expected from the application layer/sink, there are additional aspects to restart the UE timer for feedback based on status of feedback received from the next SAT. A NW/SAT may indicate the first satellite in which the feedback is potentially expected to be sent. If the CN cannot deliver the feedback to SAT3 due to other pending data, it may provide an indication via SAT3 that feedback is deferred, potentially including what SAT will provide the feedback instead.

SAT3 may indicate this information via paging or RRC connection so that UE can restart the timer for feedback. For example, if feedback is with CN it can be expected to arrive via next SAT (as indicated by SAT3).

The UE may utilize the feedback information to prevent (application layer) timers to expire such that retransmission of the uplink data or application layer failure is prevented.

The UE may utilize the feedback information to adjust its cell search and/or paging monitoring pattern to when relevant satellites/cells (carrying feedback) are available.

It is a pre-requisite that the satellite serving the UE is aware of timing of future NTN-GW connectivity of the serving satellite, timing of upcoming satellites in the area of the UE and timing of upcoming satellites' future NTN-GW connectivity.

This is required to determine which satellites will be able to provide feedback to the UE, and inform the UE which satellites will be able to provide the feedback and when. Specifically, the order of connections should be:
1. Serving satellite has core network connectivity
2. Core network has connectivity with the “application sink”
3. Core network has connectivity with the future satellite(s)
4. Future satellite(s) cover the area of the UE.

Since the data transport and processing is at the milliseconds or seconds scale and the time between satellites is expected to be at minutes/hours scale it is deemed feasible for the serving satellite to perform these predictions.

The first base station may receive at least one of location information and coverage information for the first base station and a plurality of further base stations and determine the at least one further base station based on the at least one of location information and coverage information. In an example embodiment, the core network (potentially a satellite control center) provides the satellites with information on ephemeris for other satellites and the location of relevant NTN-GWs. In release 17, the satellites in discontinuous coverage provide ephemeris for other satellites.

The first base station may receive location information for gateways of the core network and determine the at least one further base station based on the location information. For example, the NTN-GW locations may be shared between CN and RAN i.e. the RAN-CN interface is enhanced with a container for this information. This enables the serving satellite to inform the UE about the proposed first information.

In an alternative embodiment, a node in the CN is responsible for pre-computing which target satellites will provide coverage to certain areas at specific points in time, where the certain areas and specific points in time are based on the ephemeris of the satellite, which is to receive the pre-computed data. The determining of the target satellites is based on the pre-requisites above, i.e. the right order of NTN-GW connectivity has taken place. In this embodiment, the first base station receives an indication of the at least one further base station from the core network.

Table 1 illustrates how a CN node may determine SAT A's locations at time X, Y and Z to be location 1, 2, and 3, respectively. The CN node determines when SAT A will have CN connectivity after time X, Y and Z, respectively, i.e. X′, Y′, and Z′. Then the CN node determines which satellites will have CN connectivity after X′, Y′, and Z′, and cover location 1, 2, and 3 after X′,Y′ and Z′. Note the CN connectivity has to happen before the satellite reaches the designated area, e.g. the target satellite reaches the location at time X′″ after having connected with CN at time X″ where X′″>X″>X′>X.

The time where the target satellites reach the respective location is given as (Time) in the last column of table 1. For example, the CN node determines that SAT B will be at location 1 at time B, which is after X′, while SAT C will be at the same location at time C.

TABLE 1

| | SAT A location | Target satellites |
|---|---|---|
| Time X | 1 | SAT B (Time B), SAT C (Time C) |
| Time Y | 2 | SAT D (Time D) |
| Time Z | 3 | SAT E (Time E), SAT F (Time F) |

By enabling the CN node to provide the pre-computed set of target satellites with reference to location and time, the SAT A is able to inform the UE when the UE can expect feedback depending on its location. If such pre-computed data is not available the satellite may identify the target satellites on its own, following the same procedure.

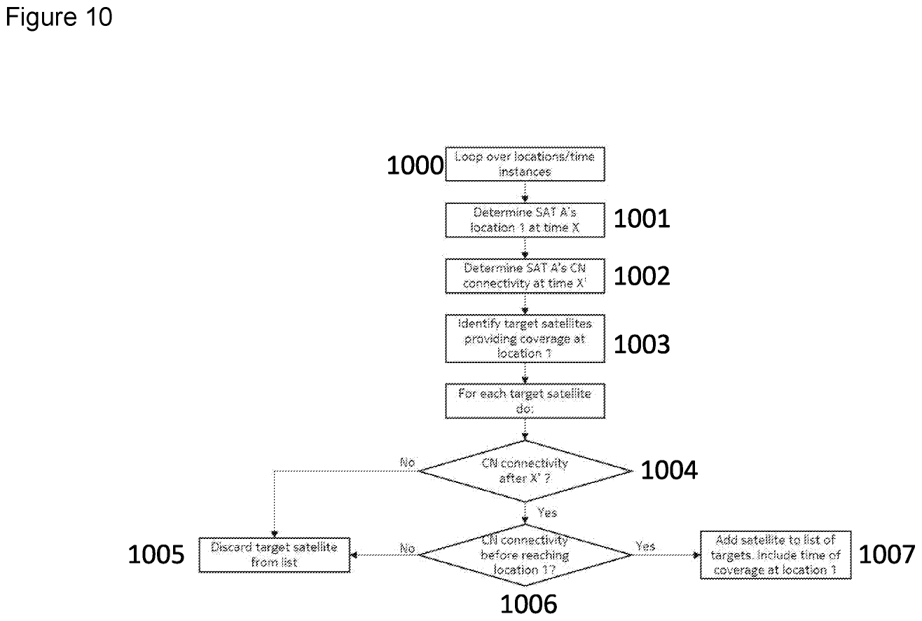

FIG. 10 shows a flow diagram of a procedure for identification of target satellites as described with reference to table 1.

At 1001, SAT A's location 1 at time X is determined. At 1002, SAT A's CN connectivity at time X′ is determined. At 1003, target satellites providing coverage at location 1 are identified. At 1004, it is determined for each target satellite if there is CN connectivity after X′. If no, the target satellite is discarded from the list at 1005. If yes, at 1006 it is determined whether the target satellite has CN connectivity before reaching location 1. If yes, at 1007 the satellite is added to a list of targets. The time of coverage at location 1 is included. If no, the target satellite is discarded from the list at 1005. The process shown in FIG. 10 is looped, 1000, over locations and time instances.

Assuming the relevant information is available in the serving satellite, the following options are proposed to ensure the feedback is forwarded to the right satellite(s). This is an important aspect, because usually feedback information will return to the entity, which forwarded the original application data (the options are given in context of the scenario of FIGS. 8 and 9).

When SAT1 sends the UL data to CN, the SAT1 also informs CN that the feedback shall be sent to SAT3

SAT1 is able to directly inform the UE about SAT3 providing potential feedback

When SAT1 sends the UL data to CN, the SAT1 also informs the CN that the feedback shall be sent to the next satellite(s) providing coverage to the same area as SAT1 is in (was in at time of receiving UE data). Instead of “same area” it can also be “UE location”, or “UE” (i.e. link to tracking area). The CN may ask satellite control center about SAT/eNB IDs for the specific area, such that data is forwarded to those satellites/eNBs

This may enable the CN to set the destination field of the IP packet to the address of e.g. SAT3. The data will then be routed through NTN-GW2 at the right time. This requires the RAN-CN interface is enhanced with a container for the destination address/satellite/eNB ID.

SAT1 may also provide information about multiple satellites which can provide feedback if SAT1 is not 100% sure which satellite will be covering the UE or not sure whether feedback will be available.

When determining the destination address the satellite may utilize the pre-computed information of Table 1 if available.

The method may comprise determining the at least one further base station based on predicted movement of the user equipment. In other words, UE movement may be taken into account by expanding the location of the UE to an area when doing the calculation. The area represents the area the UE can move into within a certain time. SAT1 may provide an indication of the different satellites and the times they are covering this area to the UE. Additionally, SAT1 may explicitly add the amount of movement considered or the coverage area. Alternatively, the UE's trajectory may be provided if it is known (e.g. if the UE is on a ship with a known route).

In an additional embodiment, the serving satellite informs the UE about time to get feedback in neighbor area(s)/cell(s) if the UE is likely to move. For network simplicity it may be beneficial to limit to one Tracking Area. If the UE is known to move it may be beneficial to prepare paging escalation (feedback distribution to more satellites). This action may also be performed if the UE has shared its itinerary with the network.

In one further embodiment, if UE has performed tracking area update (TAU) it should consider that feedback is not available in the new satellite to which it performed the TAU. Since the new satellite will not know when feedback can be available, the UE should monitor paging from now on.

In one embodiment, if NTN-GW locations are known to the UE, the UE can estimate which future satellites will have communicated with the CN. The UE may then decide which satellites to monitor, while also accounting for CN processing and routing delays (i.e. some minimum time threshold).

An apparatus may comprise means for providing data from a user equipment to a first base station, the first base station having discontinuous connectivity with a core network and receiving from the first base station, first information comprising an indication of at least one further base station from which feedback information associated with the data is to be provided at a later point in time, the at least one further base station having discontinuous connectivity with the core network.

Alternatively, or in addition, an apparatus may comprise means for receiving, at a first base station, data from a user equipment, the first base station having discontinuous connectivity with a core network and providing, to the user equipment and to the core network from the first base station, first information comprising an indication of at least one further base station from which feedback information associated with the received data is to be provided at a later point in time, the at least one further base station having discontinuous connectivity with the core network.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. A user equipment comprising: at least one processor and at least one memory storing instructions that, when executed by the at least one processor, cause the user equipment at least to:
provide data from the user equipment to a first base station, the first base station having discontinuous connectivity with a core network; and
receive from the first base station, first information comprising an indication of at least one further base station from which feedback information associated with the data is to be provided at a later point in time, the at least one further base station having discontinuous connectivity with the core network.

2. The user equipment according to claim 1, wherein the first information comprises an indication of a time when the at least one further base station will provide coverage to the user equipment.

3. The user equipment according to claim 1, wherein the indication of the at least one further base station comprises an indication of a cell or a tracking area associated with the at least one further base station.

4. The user equipment according to claim 1, wherein the user equipment is caused to receive the first information in user equipment specific signalling or in broadcast information.

5. The user equipment according to claim 1, wherein the first base station and the at least one further base station comprise a mobile base station.

6. The user equipment according to claim 5, wherein the mobile base station is mounted on a non-terrestrial satellite.

7. The user equipment according to claim 1, wherein the apparatus user equipment is further caused to receive second information comprising an indication from the at least one further base station that the feedback information is deferred.

8. The user equipment according to claim 7, wherein the second information comprises an indication of a second further non base station from which the feedback information is to be provided.

9. The user equipment-according to claim 7, wherein the second information comprises an indication of a second further non base station from which the feedback information is to be provided; and wherein the second information comprises an indication of a time when the at least one second further base station will provide coverage to the user equipment.

10. The user equipment-according to claim 8, wherein the second information comprises an indication of a second further non base station from which the feedback information is to be provided; and
wherein the indication of the at least one second further base station comprises an indication of a cell or a tracking area associated with the at least one second further base station.

11. The user equipment according to claim 7, wherein the second information comprises an indication of a second further non base station from which the feedback information is to be provided; and
wherein the user equipment is caused to receive the second information in user equipment specific signalling or in broadcast information.

12. A first base station comprising: at least one processor and at least one memory storing instructions that, when executed by the at least one processor, cause the first base station at least to:
receive, at the first base station, data from a user equipment, the first base station having discontinuous connectivity with a core network; and
provide, to the user equipment and to the core network from the first base station, first information comprising an indication of at least one further base station from which feedback information associated with the received data is to be provided at a later point in time, the at least one further base station having discontinuous connectivity with the core network.

13. The first base station according to claim 12, wherein the first base station is caused to receive location information for gateways of the core network and determine the at least one further base station based on the location information.

14. The first base station according to claim 12, wherein the first base station is caused to receive at least one of location information and coverage information for the first base station and a plurality of further base stations and determine the at least one further base station based on the at least one of location information and coverage information.

15. The first base station according to claim 12, wherein the first base station is caused to determine the at least one further base station based on predicted movement of the user equipment.

16. The first base station according to claim 12, wherein the first base station is caused to receive an indication of the at least one further base station from the core network.

17-18. (canceled)

19. A method comprising:
providing data from a user equipment to a first base station, the first base station having discontinuous connectivity with a core network; and
receiving, by the user equipment from the first base station, first information comprising an indication of at least one further base station from which feedback information associated with the data is to be provided at a later point in time, the at least one further base station having discontinuous connectivity with the core network.

20-22. (canceled)
